(19) United States
(12) Patent Application Publication
(10) Pub. No.: US 2024/0242027 A1
(43) Pub. Date: Jul. 18, 2024

(54) METHOD AND APPARATUS WITH TEXT CLASSIFICATION MODEL

(71) Applicants: SAMSUNG ELECTRONICS CO., LTD., Suwon-si (KR); Seoul National University R&DB Foundation, Seoul (KR)

(72) Inventors: Jongseok KIM, Suwon-si (KR); Hyun Oh SONG, Seoul (KR); Deok Jae LEE, Seoul (KR)

(73) Assignees: SAMSUNG ELECTRONICS CO., LTD., Suwon-si (KR); Seoul National University R&DB Foundation, Seoul (KR)

(21) Appl. No.: 18/336,578

(22) Filed: Jun. 16, 2023

(30) Foreign Application Priority Data
Jan. 13, 2023 (KR) 10-2023-0005370

(51) Int. Cl. G06F 40/279; G06F 40/247

(52) U.S. Cl. CPC G06F 40/279; G06F 40/247

(57) ABSTRACT

A method and apparatus for classifying a text using a text classification model are disclosed. In one general aspect, an apparatus is for outputting a classification result for an input text including words by using a text classification model, and the apparatus includes: one or more processors; a memory including instructions configured to cause the one or more processors to: determine whether the input text indicates an anomaly; and responsive to determining that the input text indicates an anomaly: determine saliencies of the respective words; select target words from among the words based on the saliencies; generate a replaced text by replacing, in the input text, the selected words with other words; and obtain a text classification result of the input text based on an inference upon the replaced text by the text classification model receiving the replaced text as an input.

### CROSS-REFERENCE TO RELATED APPLICATIONS

This application claims the benefit under 35 USC § 119(a) of Korean Patent Application No. 10-2023-0005370, filed on Jan. 13, 2023, in the Korean Intellectual Property Office, the entire disclosure of which is incorporated herein by reference for all purposes.

### BACKGROUND

### 1. Field

The following description relates to a method and apparatus with a text classification model.

### 2. Description of Related Art

As social interest in machine learning technology increases, machine learning technology is widely applied to various technical fields, such as autonomous driving and biometrics. Recently, adversarial attacks against AI applications have been increasingly attempted by taking advantage of the fact that an inference result of machine learning is not explainable. For example, during biometric authentication, such as face/voice/fingerprint/iris recognition, or during text classification, an external attacker (e.g., a hacker) may use the gradient value of gradient descent used in a machine learning algorithm or a greedy algorithm to carry out an adversarial attack that forges/falsifies/deceives a result of a deep learning model.

The above description has been possessed or acquired by the inventor(s) in the course of conceiving the present disclosure and is not necessarily an art publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus is for outputting a classification result for an input text including words by using a text classification model, and the apparatus includes: one or more processors; a memory including instructions configured to cause the one or more processors to: determine whether the input text indicates an anomaly; and responsive to determining that the input text indicates an anomaly: determine saliencies of the respective words; select target words from among the words based on the saliencies; generate a replaced text by replacing, in the input text, the selected words with other words; and obtain a text classification result of the input text based on an inference upon the replaced text by the text classification model receiving the replaced text as an input.

The replacing the selected words may include replacing the selected words with synonyms thereof.

The instructions may be further configured to cause the one or more processors to, responsive to determining that the input text does not indicate an anomaly, obtain the text classification result of the input text from the text classification model receiving the input text and performing the text classification result.

The instructions may be further configured to cause the one or more processors to: obtain a first probability of a first label of the input text as output from the text classification model based on receiving the input text; obtain a second probability of a second label of the input text with one word thereof omitted therefrom based on the text classification model receiving the word-omitted input text as an input; and determine saliency of the one word based on a difference between the first and second probabilities.

The instructions may be further configured to cause the one or more processors to: obtain a compressed version of the input text from an encoder that receives the input text as an input; obtain a decompressed version of the input text from a decoder that receives the compressed version of the input text as an input; and determine whether the input indicates an anomaly based on a reconstruction error based on the input text and the decompressed version of the input text.

The saliencies may be determined based on a back propagation algorithm.

The instructions may be further configured to cause the one or more processors to: responsive to determining that the input text indicates an anomaly: generate replaced texts by replacing the selected words in instances of the input text with the other words; obtain probability values of inferred labels of the respective replaced texts from the text classification model, which receives the replaced texts as inputs; and obtain the text classification result of the input text based on the probability values of the inferred labels of the respective replaced texts.

The instructions may be further configured to cause the one or more processors to: determine an average probability value of the inferred labels based on the probability values; and obtain the text classification result of the input text based on the average probability value.

The selected words may be selected based on having respective saliencies above a threshold.

The selecting the target words may include selecting a preset number of words based on the saliencies.

In another general aspect, a text classification method is performed by a computing apparatus, the text classification method includes: receiving an input text including words; determining whether the input text indicates an anomaly; responsive to determining that the input text indicates an anomaly: determining saliency measures of the words, respectively; selecting some words from among the words based on the saliency measures; generating a replaced text by replacing the selected words in the input text with other words; and obtaining a text classification result of the input text from a text classification model receiving the replaced text as an input and performing inference thereon to generate the text classification result.

The generating of the replaced text may include replacing the selected words with synonyms thereof.

The method may further include receiving a second input text, determining that the second input text does not indicate an anomaly, and in response obtaining a text classification of the second input text from the text classification model receiving, and inferencing on, the second input text.

The determining of the saliency measures may include: obtaining a first probability of a label of the input text predicted by the text classification model inferencing on the input text; obtaining a second probability of a label a version of the input text predicted by the text classification model inferencing on version of the input text, the version of the input including the input text with a word deleted therefrom; and determining saliency of the word based on a difference between the first and second probabilities.

The determining of whether the input text indicates an anomaly may include: obtaining a reconstruction of the input text generated by an auto-encoder neural network inferencing on the input text; and determining whether the input text indicates an anomaly based on reconstruction error of the reconstruction of the input text relative to the input text.

The saliency measures may be determined based on a back propagation algorithm.

The generating of the replaced text includes generating a plurality of replaced texts by replacing the selected words in the input text with the other words, and wherein the obtaining of the text classification result includes: obtaining classifications of the replaced texts, respectively, from the text classification model, which receives the replaced texts as inputs; and obtaining the text classification result of the input text based on a cardinality of the classifications.

The obtaining of the text classifications based on a cardinality of the classifications includes: determining a number of classifications that have a value; and determining whether the number of classifications meets a condition.

The obtaining of the text classification result may include obtaining classifications of the replaced texts, respectively, from the text classification model, and obtaining the text classification result of the input text based on a ratio of classification results having a given value.

In another general aspect, a method includes: determining a reconstruction error between an input text and a reconstruction of the input text; based on the reconstruction error, determining saliency scores of words of the input text; selecting target words from among the words based on the saliency scores of the target words being higher than the saliency scores of the other words; forming target versions of the input text by, for each target word, forming a corresponding target version of the input text by replacing, in an instance of the input text, the corresponding target word with a synonym thereof; obtaining predictions of the respective target versions of the input text from a text classification neural network performing inferences on the respective target versions of the input text; and determining a text classification of the input text based on the predictions of the target versions of the input text.

Other features and aspects will be apparent from the following detailed description, the drawings, and the claims.

### BRIEF DESCRIPTION OF THE DRAWINGS

FIG. 1 illustrates an overview of an example text classification apparatus, according to one or more embodiments.

FIG. 2 illustrates an example operation in which a text classification apparatus determines saliency, according to one or more embodiments.

FIG. 3 illustrates an example operation in which a text classification apparatus generates a replaced text, according to one or more embodiments.

FIG. 4 illustrates an example operation in which a text classification apparatus generates replaced texts, according to one or more embodiments.

FIG. 5 illustrates an example operation in which a text classification apparatus obtains a text classification result, according to one or more embodiments.

FIG. 6 illustrates example operations of a text classification method, according to one or more embodiments.

FIG. 7 illustrates an example operation of classifying an input text message using a text classification apparatus, according to one or more embodiments.

FIG. 8 illustrates an example operation of classifying an input review using a text classification apparatus, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

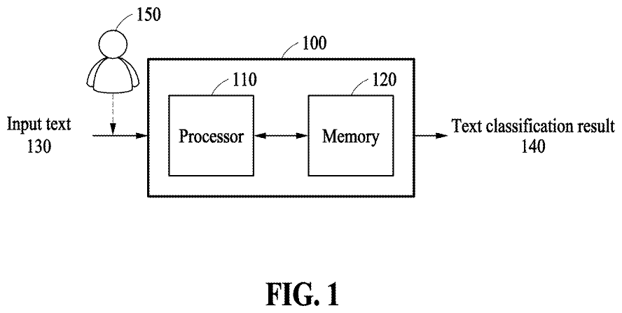

FIG. 1 illustrates an overview of an example text classification apparatus, according to one or more embodiments.

Referring to FIG. 1, a text classification apparatus 100 for classifying an input text is shown. The text classification apparatus 100 may obtain (e.g., infer) a text classification result for the input text, using a trained text classification model. To defend against an adversarial attack, the text classification apparatus 100 may apply a different classification algorithm according to whether the input text has been determined to have been subjected to an adversarial attack.

The text classification apparatus 100 may include a memory 120 including instructions and a processor 110 configured to execute the instructions. The processor 110 may control at least one other component (e.g., a hardware or software instructions component) of the text classification apparatus 100 and may perform various types of data processing or operations. As at least part of data processing or operations, the processor 110 may store instructions or data received from the other component in the memory 120, process the instructions or data stored in the memory 120, and store result data obtained therefrom in the memory 120. Operations performed by the processor 110 may be generally the same as those of the text classification apparatus 100.

The memory 120 may store information necessary for the processor 110 to perform the processing operation. For example, the memory 120 may store instructions to be executed by the processor 110 and may store related information while software or a program (in the form of instructions) is executed by the text classification apparatus 100. The memory 120 may include volatile memory, such as random access memory (RAM), dynamic RAM, and/or non-volatile memory known in the art, such as flash memory.

The memory 120 may include instructions for executing or operating a text classification model. The text classification model may output a text classification result 140 for an input text 130 that is input under control by the processor 110. The processor 110 may obtain the text classification result 140 corresponding to the input text 130 from the text classification model receiving the input text 130 as an input.

The input text 130 may be, for example, a text message received through a smartphone or a review uploaded to the Internet. However, examples of the input text 130 are not limited thereto. The text classification model may be based on a binary classification algorithm that classifies the text classification result 140 as positive or negative. However, examples of the classification result output by the text classification result 140 may not be limited thereto.

The text classification apparatus 100 may receive the input text 130, which has been subjected to an adversarial attack from a malicious user 150. In general, the term “adversarial attack” may collectively refer to a security risk that may be caused in an adversarial environment by vulnerabilities in a machine learning algorithm, for example, a machine learning algorithm that may be receive and learn from external inputs (e.g., an “open” online machine learning algorithm). The types of adversarial attacks may include a poisoning attack that weakens or destroys a machine learning model by injecting malicious training data, an evasion attack that deceives machine learning by perturbing data during an inference process of a machine learning model, and an inversion attack that steals training data using reverse engineering. The text classification apparatus 100 may effectively defend against at least the evasion attack among adversarial attacks.

In order to safely protect a machine learning model (e.g., a neural network) from such adversarial attacks, several techniques have been proposed, including, for example, an adversarial training technique, a gradient masking/distillation technique, and a feature squeezing technique. The adversarial training technique may involve all (or most of) the possible adversarial cases being included in a training data set when a machine training model is trained. The gradient masking/distillation technique may prevent the gradient of a training model from being exposed as an output or make the gradient itself inconspicuous in the structure of the training model, which is similar to a normalization method, thus giving no hint to a training direction caused by an adversarial attack. The feature squeezing technique may be a method of adding a training model that determines whether given input data is an adversarial case, separately from an original training model.

Existing techniques of defending against adversarial attacks may have some issues that require additional training data and training algorithms. In addition, the existing techniques of defending against adversarial attacks may need additional training, so that such techniques may not be suitable for technical fields that require real-time response. The text classification apparatus 100 may provide a method of defending against an adversarial attack without necessarily requiring additional re-training of the text classification model.

The processor 110 of the text classification apparatus 100 may receive the input text 130. The malicious user 150 may carry out an adversarial attack on the input text 130 and thus induce the text classification model to mis-classify the input text 130. The processor 110 may determine whether the input text 130 has been subjected to the adversarial attack. The memory 120 may include instructions for executing an anomaly detector for determining whether the received input text 130 has been subjected to the adversarial attack. Under control by the processor 110, the anomaly detector may determine whether the input text 130 has been subjected to an adversarial attack or whether the input text 130 has an anomaly.

The anomaly detector may be based on a trained auto-encoder model but the type of anomaly detector is not limited thereto. An auto-encoder model (e.g., back-to-back neural networks) may be a type of deep learning model that includes an encoder model and a decoder model, which may be respective neural networks. When input data is input to the auto-encoder model, the encoder compresses (e.g., encodes or reduces the dimensionality of) the into a low-dimensional space, and the decoder reconstructs (decodes) the compressed/encoded data back into the dimensionality of the input data. The auto-encoder model may learn patterns of normal data through training and reconstruct normal data with a small reconstruction error. The reconstruction error be a difference between data of the input text 130 and data of the reconstructed approximation of the input text.

The processor 110 may determine whether the input text 130 has an anomaly based on the reconstruction error. The processor 110 may obtain the compressed/encoded input text from the encoder (generated thereby based on receiving the input text 130 as an input). The processor 110 may obtain the reconstructed approximation of the input text from the decoder (generated thereby based on receiving the compressed/encoded input text as an input). The processor 110 may obtain the reconstruction error based on the input text 130 and the reconstructed input text.

The processor 110 may determine whether the input text 130 has been subjected to an adversarial attack based on the reconstruction error. When the reconstruction error is greater than or equal to a threshold value, the processor 110 may determine that the input text 130 has been subjected to an adversarial attack. When the reconstruction error is less than the threshold value, the processor 110 may determine that the input text 130 has not been subjected to an adversarial attack.

When it is determined that the input text 130 has not been subjected to the adversarial attack, the processor 110 may obtain a directly text classification result corresponding to the input text 130 from the text classification model receiving the input text 130 as an input.

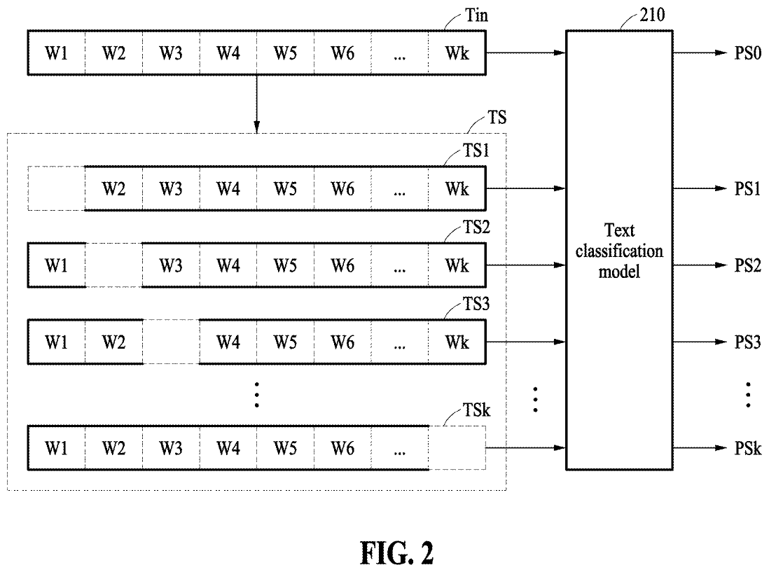

When it is determined that the input text 130 has been subjected to the adversarial attack, the processor 110 may determine saliencies of respective words included in the input text 130. The saliency of a word may be a degree (score, measure, etc.) to which the word affects a text classification result inferred by the text classification model based on the input text 130. The processor 110 may determine saliencies of words through various methods. As used herein, “word” does not refer to unigrams per se but rather refers to single words and word phrases, i.e., short phrases that represent a same concept or entity. For example “New York City” may be considered to be a word. An operation of determining the saliencies of words by the processor 110 is described with reference to FIG. 2.

The processor 110 may determine the saliencies of the words and select some of the words based on the saliencies. After determining the saliencies of the respective words, the processor 110 may select those words having high saliency. When the processor 110 selects some words, it may select as many words as a preset number. The processor 110 may generate a replaced text by replacing, in the input text 130, the selected/target words with other (replacement) words. The processor 110 may obtain a text classification result corresponding to the input text 130 by obtaining a text classification result from the text classification model based on the text classification model inferencing on the replaced text (which is input to the text classification model).

In an example, when the processor 110 generates a replaced text, it may do so by replacing, in an instance of the input text, a selected word with a synonym thereof. For example, when the input text 130 is “the puppy is so lovely”, the input text 130 may be determined to include the words “the puppy”, “so”, and “lovely”. When saliencies are determined for the respective words “puppy”, “so”, and “lovely”, and “lovely” has the highest saliency, the processor 110 may replace “lovely” with a synonym (e.g., “cute”) to generate a first replaced text “The puppy is so cute”. The processor 110 may obtain a text classification result of the input text 130 for the first replaced text “The puppy is so lovely” from the text classification model. Or, “puppy” may be replaced with “dog” and a second replaced text, “The dog is so lovely”, may be input to the text classification model to obtain another text classification result corresponding to the original input text 130.

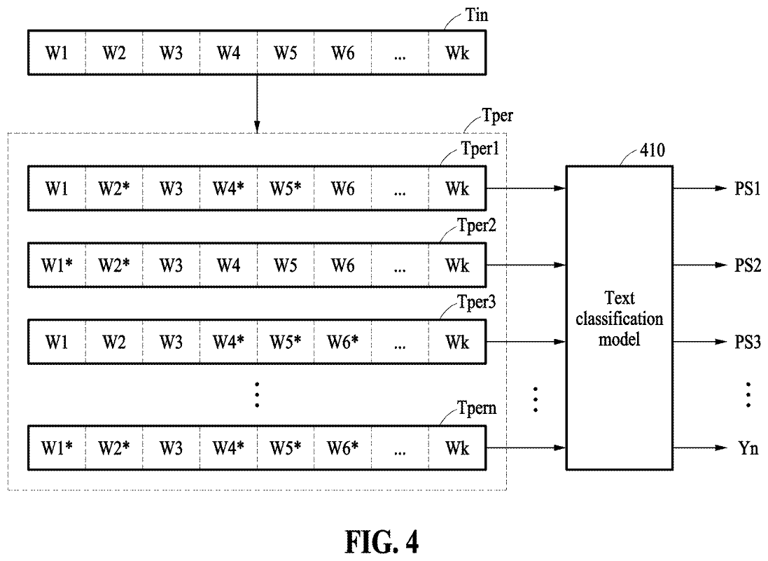

In the above example, only one word of the input text 130 is replaced and only one replaced text is generated. However, the number of replaced words and/or the number of generated replaced texts may vary depending on an example or implementation. When the text classification apparatus 100 has abundant computational resources, multiple replaced texts may be generated and respective classification results may be collected, and the classification results may lead to a label predicted with high probability for the text classification result. An operation of generating replaced texts by the text classification apparatus 100 is described with reference to FIG. 4.

In general, when the malicious user 150 attempts an adversarial attack on the input text 130, the malicious user 150 may likely generate an adversarial sample obtained by replacing a word that has a significant impact (or high saliency) on the inference of the text classification model among words included in the input text 130, thus easily inducing misjudgment of the text classification model. The text classification apparatus 100 may defend against the adversarial attack by selecting words expected to have been replaced by the malicious user 150 based on saliency, replacing the selected words with other synonyms, and inputting the replaced words to the text classification model. Since the text classification apparatus 100 does not need new training with new training data to address an adversarial attack, the text classification apparatus 100 may defend against new adversarial attacks without additional cost and/or time. In addition, since the text classification apparatus 100 obtains the text classification result based on the replaced text only when it is determined that the input text 130 is likely to have been subjected to the adversarial attack, the text classification apparatus 100 may alleviate the deterioration of accuracy of a classification result that is in a trade-off relationship with the robustness of the adversarial attack.

FIG. 2 illustrates an example operation in which a text classification apparatus determines saliency, according to one or more embodiments.

Referring to FIG. 2, an input text Tin received by a text classification apparatus (e.g., the text classification apparatus 100 of FIG. 1) may include a number (k) of consecutive words W1-Wk. The input text Tin may be labeled with a label yᵢₙ. A processor (e.g., the processor 110 of FIG. 1) may obtain a probability PS0 that of a label yᵢₙ corresponding to the input text Tin as output from a text classification model receiving the input text Tin as an input. The processor may generate texts TS (TS1 to TSk), where each text therein is obtained by deleting one word from the input text Tin. The processor may obtain probabilities of PS1 to PSk of TS1 to TSk, respectively, of the label yᵢₙ corresponding to the input text Tin as output from the text classification model by inputting the texts TS (which are obtained by deleting one word from the input text Tin). For each generated text in TS (represented as Ti), the processor may determine saliency of the one word (e.g., the i-th word) deleted therefrom based on a difference between (i) the probability PS0 that the label yᵢₙ corresponds to the input text Tin (as output from the text classification model receiving the input text as an input); and (ii) the probability PSi that that the label yᵢₙ corresponds to the input data Tin (as output from the text classification model based on receiving, as an input, the text Ti obtained by deleting one word (the i-th word) from the input text Tin). Repeated for i from 1 to k, saliencies s₁ to sₖ may thus be obtained. The saliency sᵢ of an i-th word among the words in the input text Tin may be defined as in Equation 1 below.

$${s}_{i} = \vert {f}_{{y}_{in}} ( {t}_{in} ) - {f}_{{y}_{in}} ( {w}_{1} , {w}_{2} , ... , {w}_{i - 1} , {w}_{i + 1} , ... , {w}_{k} ) \vert \qquad Equation 1$$

fyᵢₙ(tᵢₙ) denotes the probability that the label yᵢₙ corresponds to the input text Tin as output by the text classification model receiving the input text Tin as an input. fyᵢₙ (tᵢₙ) may correspond to the probability PS0 of FIG. 2. fyᵢₙ(w₁, w₂, . . . , wᵢ₋₁, wᵢ₊₁, . . . , wₖ) denotes the probability that the label yᵢₙ corresponds to the input text Tin as output by the text classification model receiving, as an input, a text obtained by deleting the i-th word from the input text Tin (as indicated by the i−1 and i+1 index sequence).
fyᵢₙ (w₁, w₂, . . . , wᵢ₋₁, wᵢ₊₁, . . . , wₖ) may correspond to the PSi probability among the probabilities of PS0 to PSk of FIG. 2.
s₁ may be a difference between (i) the probability PS0 of the label yᵢₙ as output by the text classification model receiving the input text Tin as an input (the first term of Equation 1) and (ii) the probability PS1 of the label yᵢₙ as output by the text classification model receiving, as an input, a text TS1 obtained by deleting a word W1 from the input text Tin (the second term of Equation 2). s₂ may be a difference between (i) the probability PS0 of the label yᵢₙ as output by the text classification model receiving the input text Tin as an input and (ii) the probability PS2 of the label yᵢₙ as output by the text classification model receiving, as an input, a text TS2 obtained by deleting a word W2 from the input text Tin. sₖ may be a difference between (i) the probability PS0 of the label yᵢₙ as output by the text classification model receiving the input text Tin as an input and (ii) the probability PSk of the label yᵢₙ as output by the text classification model receiving, as an input, a text TSk obtained by deleting a word Wk from the input text Tin.

Saliency may increase in accordance with increasing difference between the two probabilities described above. The greater the impact that one word has on a text classification result of the text classification model receiving the input text Tin as an input, the greater the value of sᵢ.

The processor may determine saliency based on a back propagation algorithm. When the processor determines the saliency based on the back propagation algorithm, the saliency of the i-th word may be defined as in Equation 2 below.

$${s}_{i} = \frac{\partial {f}_{{y}_{in}} ( {t}_{in} )}{\partial {w}_{i}} \qquad Equation 2$$

fyᵢₙ (tᵢₙ) denotes the probability of the label yᵢₙ corresponding to the input text Tin as output by the text classification model receiving the input text Tin as an input. To calculate an impact/influence that one word has on the probability of the label yᵢₙ as output by the text classification model receiving the input text Tin as an input (i.e., the saliency of the one word), the processor may perform a partial derivative on the probability of the label yᵢₙ as output.

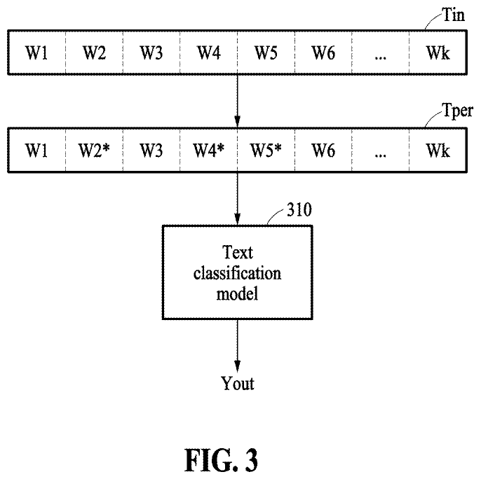

FIG. 3 illustrates an example operation in which a text classification apparatus generates a replaced text, according to one or more embodiments.

A processor (e.g., the processor 110 of FIG. 1) of a text classification apparatus (e.g., the text classification apparatus 100 of FIG. 1) may obtain a text classification result Yout corresponding to an input text Tin, using a text classification model 310. A configuration of the input text Tin may be understood by referring to the input text Tin described above with reference to FIG. 2.

The processor may select some words based on saliencies of words W1-Wk. The processor may select words based on an assumption that sampling probability function p(i) has a higher probability value as saliency increases. The sampling probability function p(i) may be defined as in Equation 3 below.

$$p ( i ) ∝ {e}^{{Ts}_{i}} \qquad Equation 3$$

sᵢ denotes the saliency of an i-th word among the words in the input text Tin, and sᵢ refers to the example described above with reference to FIG. 2. T may be a hyperparameter. The size of the sampling probability function p(i) may be proportional to the size of saliency sᵢ of one word. The processor may perform sampling on positions of words having high saliency and select words based on the sampling probability function.

Referring to the example shown in FIG. 3, the processor may select words W2, W4, and W5 from the input text Tin based on their respective saliencies. The processor may generate a replaced text Tper by replacing the selected words W2, W4, and W5 with other words W2*, W4*, and W5*. The processor may replace the selected words W2, W4, and W5 with respective synonyms thereof. The text classification model 310 may infer a label of the replaced text Tper by receiving the replaced text Tper. The processor may obtain the text classification result Yout corresponding to the input text Tin from the text classification model that receives the replaced text Tper as an input.

FIG. 4 illustrates an example operation in which a text classification apparatus generates replaced texts (texts that have had word(s) replaced in Tin), according to one or more embodiments.

Referring to FIG. 4, a processor (e.g., the processor 110 of FIG. 1) of a text classification apparatus (e.g., the text classification apparatus 100 of FIG. 1) may obtain a text classification result corresponding to an input text Tin. The text classification apparatus may determine whether the input text Tin has been subjected to an adversarial attack prior to performing text classification on the input text Tin. Although determining that an adversarial attack has occurred is mainly described herein as a pre-condition of word replacement techniques, an explicit determination of an adversarial attack is not necessarily required. Rather, any property of, or inference on, the input text, may serve as a basis for performing text replacement. For example, although a discrepancy between an approximation of the input text generated by an auto-encoder and the input text itself may be a tell-tale sign of an adversarial attack, such a conclusion itself is not necessarily required or even, in some implementations, implied. Where a determination of an adversarial attack is mentioned herein, the same description is equally applicable to any determination of an anomaly of the input text.

When it is determined that the input text Tin has been subjected to an adversarial attack, the processor may select words to be replaced with other words from among words included in the input text Tin. A plurality of replaced texts Tper may be generated by replacing the selected words in the input text Tin with the other words. The words to be replaced with the other words may be selected in several combinations. For example, in the input text Tin including W1, W2, W3, . . . , Wk, the several combinations may include a text Tper1, in which words W2, W4, and W5 are replaced with other words W2*, W4*, and W5*, a text Tper2, in which the words W1 and W2 are replaced with other words W1* and W2*, and a text Tper3, in which words W4, W5, and W6 are replaced with other words W4*, W5*, and W6*. The processor may generate the replaced texts Tper when the text classification apparatus has abundant computing resources, for example, or when higher accuracy is called for. The replaced texts Tper may include first to n-th replaced texts Tper1 to Tpern.

The processor may perform, n times, an operation of determining saliencies of words W1 to Wk included in the input text Tin. Each time the processor performs the operation of determining the saliencies, the saliency for each of the words W1 to Wk included in the input text Tin may change. Therefore, each time the processor performs an operation of selecting some words based on the saliencies, selected words may be different. The replaced words in each of the first to the n-th replaced texts Tper1 to Tpern are different from each other.

The selected words may be randomly (or partially randomly) replaced. Therefore, even when the same word is replaced each time the processor replaces the selected word, the replaced words may be different from each other. For example, the word W2* included in the first replaced text Tper1 may be different from the word W2* included in the second replaced text Tper2.

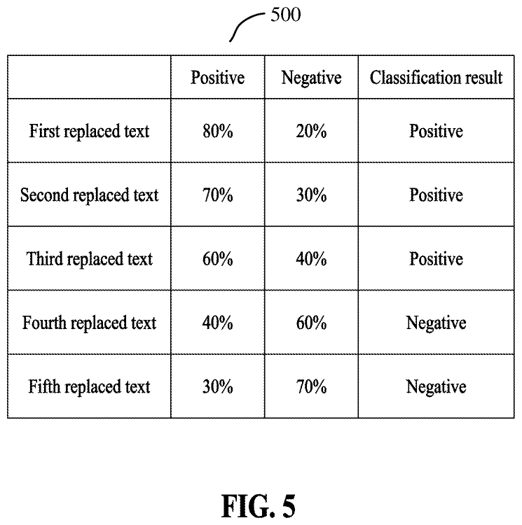

The processor may obtain classification results Y1 to Yn respectively corresponding to the replaced texts Tper1 to Tpern from a text classification model 410 that receives the replaced texts Tper as an input. The processor may obtain a text classification result for the input text Tin based on the classification results Y1 to Yn. An operation in which the processor obtains the text classification result based on the classification results Y1 to Yn is described with reference to FIG. 5.

FIG. 5 illustrates an example operation in which a text classification apparatus obtains a text classification result, according to one or more embodiments. Hereinafter, for convenience of explanation, a description is provided together with reference to FIG. 4.

FIG. 5 illustrates example 500 classification results obtained from a text classification model receiving, as an input, a set of replaced texts (first to fifth replaced texts) generated by a processor (e.g., the processor 110 of FIG. 1) of a text classification apparatus (e.g., the text classification apparatus 100 of FIG. 1). The first replaced text may correspond to the first replaced text Tper1 of FIG. 4. The classification result (positive) of the first replaced text may correspond to the classification result Y1 of the first replaced text Tper1 of FIG. 4.

The text classification model of the text classification apparatus may infer a label for each of the first to fifth replaced texts to output probability values for a “positive” label and a “negative” label. For a replaced text, the text classification model may output, as a classification result thereof, a “positive” or “negative” label according which is higher, the “positive” probability value or the “negative” probability values. In the example 500 “positive” labels and “negative” labels are inferred for replaced texts, but label types of replaced texts may vary for different implementations.

As described, the processor may obtain, from the classification model, probability values of labels that are inferred for replaced texts. The text classification model receiving the first replaced text as an input may output, as an inference result for the first replaced text, a probability value of 80% for the “positive” label, a probability value of 20% for the “negative” label, and a classification result of “positive”. Similarly, the text classification model may output a probability value for the “positive” label, a probability value for the “negative” label, and a classification result, as an inference result for each of the second to fifth replaced texts. In some embodiments, the inferred positive and negative probability values may not add up to 100%, rather there may be a third label which is “indeterminate”, and, depending on threshold settings, the corresponding replaced text may be disregarded if, for example, the probability of “indeterminate” is over 50%.

As noted, the processor may obtain a text classification result of the input text based on (i) the probability values of inferred labels for each of the plurality of replaced texts and/or (ii) the classification results corresponding to the plurality of replaced texts, respectively. For example, the processor may determine an average of the probability values of the inferred labels and may obtain the text classification result of the input text based on the average probability value.

Referring to the example 500, the processor may obtain an average “positive” probability of 56% from the “positive” probabilities of 80%, 70%, 60%, 40%, and 30%. Similarly, the processor may obtain an average “negative” probability of 44% from the “negative” probabilities 20%, 30%, 40%, 60%, and 70%. Since the average “positive” probability is greater than the average “negative” probability, the processor may obtain “positive” as the text classification result of the input text. The same result may be obtained using only “positive” probability values or only “negative” probability values by comparing the average of either average to 50%.

The processor may obtain the text classification of the input text based on whichever of the classification results has the highest cardinality. For example, the text classification model may three “positive” classifications results (for the first to third replaced texts) and, being higher than the cardinality of the “negative” classification results, may therefore output “positive” as a text classification result of the input text.

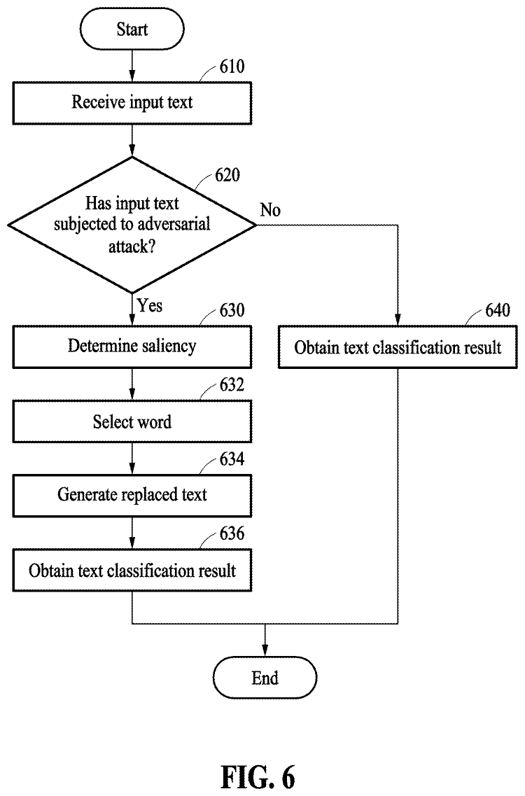

FIG. 6 illustrates example operations of a text classification method, according to one or more embodiments.

In an example, operations of the text classification method may be performed by the text classification apparatus 100 of FIG. 1.

In operation 610, a text classification apparatus may receive an input text including a plurality of words. The input text may correspond to, for example, the input text Tin of FIG. 2 or 3.

In operation 620, the text classification apparatus may determine whether the input text has been subjected to an adversarial attack, is anomalous, etc. For example, the text classification apparatus may determine whether the input text has been subjected to the adversarial attack by using an anomaly detector based on an auto-encoder model. The text classification apparatus may obtain a compressed version (encoding of) the input text from an encoder (of the auto-encoder model) that receives the input text as an input. The text classification apparatus may obtain a reconstructed version of (decoding of) the input text from a decoder (or the auto-encoder) that receives the compressed/encoded input text as an input. The text classification apparatus may obtain a reconstruction error based on the input text and the reconstructed input text. Specifically, the text classification apparatus may determine whether the input text has been subjected to an adversarial attack (or is anomalous) based on the reconstruction error. An operation in which the text classification apparatus determines whether the input text has been subjected to the adversarial attack by using the auto-encoder model may be understood by referring to the description of FIG. 1.

When it is determined that the input text has not been subjected to the adversarial attack or is not anomalous (when ‘No’ is determined in operation 620), in operation 640, the text classification apparatus may obtain a text classification result corresponding to the input text from a text classifying model that receives the input text as an input.

When it is determined that the input text has been subjected to the adversarial attack (when ‘yes’ is determined in operation 620), in operation 630, the text classification apparatus may determine saliencies of the respective words of the input text. Since a malicious user may generally carry out an adversarial attack by replacing words in an original version of the input text that have a high impact/influence on the inference of the text classification model. The text classification apparatus may determine saliencies of the words in the input text and replace words having high saliencies with other words.

The text classification apparatus may obtain a probability of a label of the input text as output from the text classification model, which receives the input text as an input and performs inference based thereon. The text classification apparatus may obtain the probability of the label corresponding to the input text as output from the text classification model receiving, as an input, a text obtained by deleting one word from the input text. The text classification apparatus may determine saliency of the one word based on a difference between the two probabilities of the input text; with and without the one word. The greater the difference between the two probabilities, the greater the probability that one word has an impact/influence on the inference of the text classification model. In this case, the saliency may be high. If the difference is above a threshold the one word may be flagged as a salient word and subjected to replacement processing.

The text classification apparatus may also determine saliency based on a back propagation algorithm. An operation in which the text classification apparatus determines the saliencies of words based on the back propagation algorithm may be understood by referring to the example described above with reference to FIG. 2.

In operation 632, the text classification apparatus may select some words from among the words of the input text based on their respective saliencies (e.g., being above a threshold). Or, the text classification apparatus may select some words as being salient based on a preset number, i.e., the top-N most salient words may be selected. The text classification apparatus may select words having high saliency based on a sampling probability function p(i) having an increasing probability value according to increasing saliency. An operation in which the text classification apparatus selects words may be understood by referring to the example described above with reference to FIG. 1.

In operation 634, the text classification apparatus may generate a replaced text by replacing a selected word in the input text with another word. The text classification apparatus may generate the replaced text by replacing the selected word with a synonym thereof. The text classification apparatus may generate a set of such replaced texts, where each replaced text is a version of the input text with one or more of the salient words replaced therein with a synonym. For example, when the text classification apparatus has sufficient operation resources, the text classification apparatus may generate many replaced texts.

In operation 636, the text classification apparatus may obtain a text classification result corresponding to the input text based on the text classification model receiving the replaced texts as an input. The text classification apparatus may obtain probability values of inferred labels of the respective replaced texts and classification results corresponding to the replaced texts, respectively, from the text classification model receiving the replaced texts as inputs. An operation in which the text classification apparatus obtains the probability values of inferred labels for the respective replaced texts and the classification results corresponding to the replaced texts, respectively, may be understood by referring to the description of FIG. 5.

The text classification apparatus may obtain the text classification result of the input text based on the probability values of the inferred labels of the respective replaced texts and/or the classification results corresponding to the replaced texts, respectively.

Specifically, for example, the text classification apparatus may determine an average probability value of the probabilities of the inferred labels of the replaced texts and may obtain the text classification result of the input text based on the average probability value.

Alternatively, the text classification apparatus may obtain the text classification result of the input text based on a classification result that is output most (highest cardinality) among the classification results. An operation in which the text classification apparatus obtains the text classification result corresponding to the input text based on the probability values of the inferred labels for each of the plurality of replaced texts and/or the classification results corresponding to the plurality of replaced texts, respectively, may be understood by referring to the description of FIG. 5.

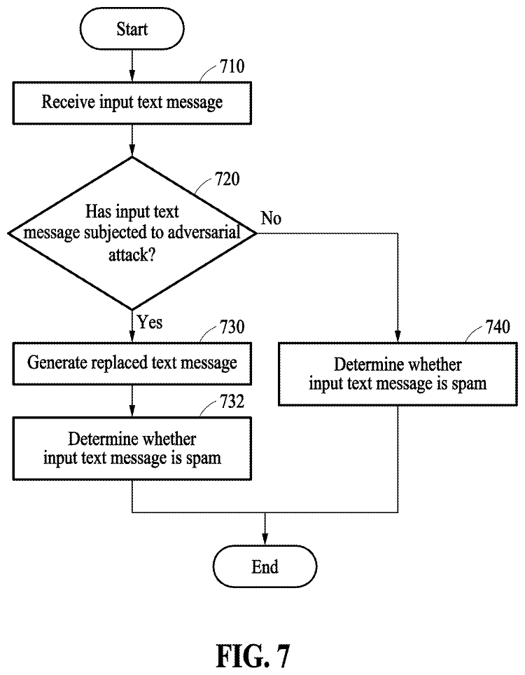

FIG. 7 illustrates an example operation of classifying an input text message using a text classification apparatus, according to one or more embodiments.

In an example, operations of a text classification method may be performed by the text classification apparatus 100 of FIG. 1. The text classification apparatus may be a device that determines, for example, whether a text message received through a mobile device, such as a smartphone, is spam.

In operation 710, the text classification apparatus may receive an input text message.

In operation 720, the text classification apparatus may determine whether the input text message has been subjected to an adversarial attack (or is an anomaly, or has a category such as spam). A malicious user may attack or formulate the input text message to induce a text classification model to classify a normal text message, which is not spam, as spam or to classify a spam text message as normal. The text classification apparatus may determine whether the input text message has been subjected to the adversarial attack by using, for example, an anomaly detector based on an auto-encoder model.

When it is determined that the input text has not been subjected to an adversarial attack or the like (when ‘No’ is determined in operation 720), in operation 740, the text classification apparatus may obtain a text classification result from the text classification model receiving the input text message as an input and may determine from the text classification result whether the input text message is spam, for example.

When it is determined that the input text message has been subjected to an adversarial attack or the like (when ‘yes’ is determined in operation 720), in operation 730, the text classification apparatus may replace some of the words in the input text message with other words to obtain a replaced text message. An operation in which the text classification apparatus generates the replaced text message may be similar to the operation described above with reference to FIGS. 1 to 6.

In operation 732, the text classification apparatus may obtain a text classification result from the text classification model receiving the replaced text message as an input and may determine whether the input text message is spam.

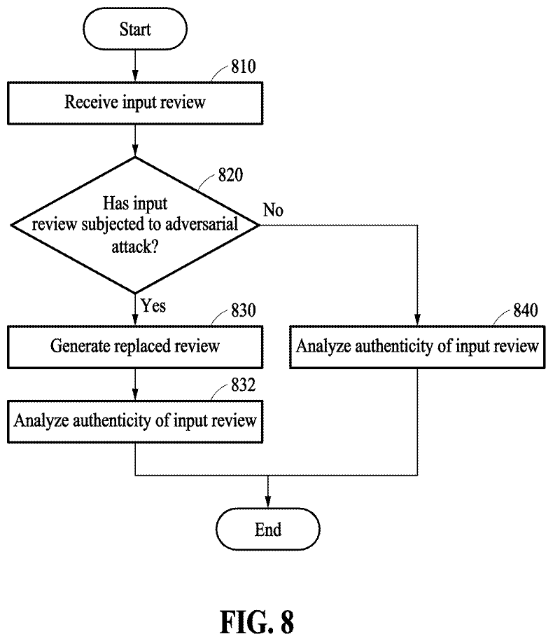

FIG. 8 illustrates an example operation of classifying an input review using a text classification apparatus, according to one or more embodiments.

In an example, operations of a text classification method may be performed by the text classification apparatus 100 of FIG. 1. The text classification apparatus may be a device for analyzing the authenticity of a review on the Internet, for example.

In operation 810, the text classification apparatus may receive an input review.

In operation 820, the text classification apparatus may determine whether the input review has been subjected to an adversarial attack, is fabricated/unauthentic, etc. A malicious user may attack an input review to induce a text classification model to classify a negative review as positive or a positive review as negative. The text classification apparatus may determine whether the input review has been subjected to the adversarial attack by using, for example, an anomaly detector based on an auto-encoder model.

When it is determined that the input review has not been subjected to the adversarial attack (when ‘No’ is determined in operation 820), in operation 840, the text classification apparatus may obtain a text classification result from the text classification model receiving the input review as an input and analyze the authenticity of the input review.

When it is determined that the input review has been subjected to the adversarial attack (when ‘yes’ is determined in operation 820), in operation 830, the text classification apparatus may replace some of words included in the input review with other words to obtain a replaced review. An operation of generating the replaced review by the text classification apparatus may be similar to the operation of generating the replaced text by the text classification apparatus described above with reference to FIGS. 1 to 6.

In operation 832, the text classification apparatus may obtain a text classification result from the text classification model receiving the replaced review as an input and may perform authenticity analysis on the input review.

The computing apparatuses, the electronic devices, the processors, the memories, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An apparatus for outputting a classification result for an input text comprising words by using a text classification model, the apparatus comprising:
one or more processors;
a memory comprising instructions configured to cause the one or more processors to:
determine whether the input text indicates an anomaly; and
responsive to determining that the input text indicates an anomaly:
determine saliencies of the respective words;
select target words from among the words based on the saliencies;
generate a replaced text by replacing, in the input text, the selected words with other words; and
obtain a text classification result of the input text based on an inference upon the replaced text by the text classification model receiving the replaced text as an input.

2. The apparatus of claim 1, wherein the replacing the selected words comprises replacing the selected words with synonyms thereof.

3. The apparatus of claim 1, wherein the instructions are further configured to cause the one or more processors to: responsive to determining that the input text does not indicate an anomaly, obtain the text classification result of the input text from the text classification model receiving the input text and performing the text classification result.

4. The apparatus of claim 1, wherein the instructions are further configured to cause the one or more processors to:
obtain a first probability of a first label of the input text as output from the text classification model based on receiving the input text;
obtain a second probability of a second label of the input text with one word thereof omitted therefrom based on the text classification model receiving the word-omitted input text as an input; and
determine saliency of the one word based on a difference between the first and second probabilities.

5. The apparatus of claim 1, wherein the instructions are further configured to cause the one or more processors to:
obtain a compressed version of the input text from an encoder that receives the input text as an input;
obtain a decompressed version of the input text from a decoder that receives the compressed version of the input text as an input; and
determine whether the input indicates an anomaly based on a reconstruction error based on the input text and the decompressed version of the input text.

6. The apparatus of claim 1, wherein the saliencies are determined based on a back propagation algorithm.

7. The apparatus of claim 1, wherein, the instructions are further configured to cause the one or more processors to:
responsive to determining that the input text indicates an anomaly:
generate replaced texts by replacing the selected words in instances of the input text with the other words;
obtain probability values of inferred labels of the respective replaced texts, from the text classification model, which receives the replaced texts as inputs; and
obtain the text classification result of the input text based on the probability values of the inferred labels of the respective replaced texts.

8. The apparatus of claim 7, wherein the instructions are further configured to cause the one or more processors to:
determine an average probability value of the inferred labels based on the probability values; and
obtain the text classification result of the input text based on the average probability value.

9. The apparatus of claim 1, wherein the selected words are selected based on having respective saliencies above a threshold.

10. The apparatus of claim 1, wherein the selecting the target words comprising selecting a preset number of words based on the saliencies.

11. A text classification method performed by a computing apparatus, the text classification method comprising:
receiving an input text comprising words;
determining whether the input text indicates an anomaly;
responsive to determining that the input text indicates an anomaly:
determining saliency measures of the words, respectively;
selecting some words from among the words based on the saliency measures;
generating a replaced text by replacing the selected words in the input text with other words; and
obtaining a text classification result of the input text from a text classification model receiving the replaced text as an input and performing inference thereon to generate the text classification result.

12. The text classification method of claim 11, wherein the generating of the replaced text comprises replacing the selected words with synonyms thereof.

13. The text classification method of claim 11, further comprising receiving a second input text, determining that the second input text does not indicate an anomaly, and in response obtaining a text classification of the second input text from the text classification model receiving, and inferencing on, the second input text.

14. The text classification method of claim 11, wherein the determining of the saliency measures comprises:
obtaining a first probability of a label of the input text predicted by the text classification model inferencing on the input text;
obtaining a second probability of a label a version of the input text predicted by the text classification model inferencing on version of the input text, the version of the input comprising the input text with a word deleted therefrom; and
determining saliency of the word based on a difference between the first and second probabilities.

15. The text classification method of claim 11, wherein the determining of whether the input text indicates an anomaly comprises:
obtaining a reconstruction of the input text generated by an auto-encoder neural network inferencing on the input text; and
determining whether the input text indicates an anomaly based on reconstruction error of the reconstruction of the input text relative to the input text.

16. The text classification method of claim 11, wherein the saliency measures are determined based on a back propagation algorithm.

17. The text classification method of claim 11, wherein the generating of the replaced text comprises generating a plurality of replaced texts by replacing the selected words in the input text with the other words, and wherein
the obtaining of the text classification result comprises:
obtaining classifications of the replaced texts, respectively, from the text classification model, which receives the replaced texts as inputs; and
obtaining the text classification result of the input text based on a cardinality of the classifications.

18. The text classification method of claim 17, wherein the obtaining of the text classifications based on a cardinality of the classifications comprises:
determining a number of classifications that have a value; and
determining whether the number of classifications meets a condition.

19. The text classification method of claim 11, wherein the obtaining of the text classification result comprises obtaining classifications of the replaced texts, respectively, from the text classification model, and obtaining the text classification result of the input text based on a ratio of classification results having a given value.

20. A method comprising:
determining a reconstruction error between an input text and a reconstruction of the input text;
based on the reconstruction error, determining saliency scores of words of the input text;
selecting target words from among the words based on the saliency scores of the target words being higher than the saliency scores of the other words;
forming target versions of the input text by, for each target word, forming a corresponding target version of the input text by replacing, in an instance of the input text, the corresponding target word with a synonym thereof;
obtaining predictions of the respective target versions of the input text from a text classification neural network performing inferences on the respective target versions of the input text; and
determining a text classification of the input text based on the predictions of the target versions of the input text.
